(19) United States
(12) Patent Application Publication
(10) Pub. No.: US 2020/0264705 A1
(43) Pub. Date: Aug. 20, 2020

(54) INFORMATION PROCESSING APPARATUS AND ELECTRONIC DEVICE

(71) Applicant: FUJITSU LIMITED, Kawasaki-shi (JP)

(72) Inventors: Kiyoshi TANINAKA, Ebina (JP); Akinori MIYAMOTO, Sagamihara (JP); Sachihiro YOUOKU, Kawasaki (JP)

(73) Assignee: FUJITSU LIMITED, Kawasaki-shi (JP)

(21) Appl. No.: 16/866,840

(22) Filed: May 5, 2020

Related U.S. Application Data
(63) Continuation of application No. PCT/JP2017/040320, filed on Nov. 8, 2017.

(51) Int. Cl. G06F 3/01; G06F 3/043; G06F 3/0488; G06F 3/044

(52) U.S. Cl. CPC G06F 3/016; G06F 3/0436; G06F 2203/014; G06F 3/0447; G06F 3/0488

(57) ABSTRACT

An information processing device includes: a memory; and a processor coupled to the memory and configured to: drive a vibrating element of an electronic device, which includes a top panel that has an operation surface, a position detection circuit that detects a position of an operational input performed on the operation surface, and the vibrating element that generates vibration on the operation surface, with a first drive signal that generates a first natural vibration in an ultrasonic band on the operation surface when the operational input is performed on the operation surface; and drive the vibrating element with a second drive signal that generates vibration in a frequency band perceivable by a human sensory organ on the operation surface when the vibrating element is driven for a predetermined time.

### CROSS-REFERENCE TO RELATED APPLICATION

This application is a continuation application of International Application PCT/JP2017/040320 filed on Nov. 8, 2017 and designated the U.S., the entire contents of which are incorporated herein by reference.

### FIELD

The embodiment relates to a drive control device, an electronic device, and a drive control method.

### BACKGROUND

Heretofore, there has been an input device.

Japanese Laid-open Patent Publication No. 2010-140102 is disclosed as related art.

### SUMMARY

According to an aspect of the embodiments, an information processing device includes: a memory; and a processor coupled to the memory and configured to: drive a vibrating element of an electronic device, which includes a top panel that has an operation surface, a position detection circuit that detects a position of an operational input performed on the operation surface, and the vibrating element that generates vibration on the operation surface, with a first drive signal that generates a first natural vibration in an ultrasonic band on the operation surface when the operational input is performed on the operation surface; and drive the vibrating element with a second drive signal that generates vibration in a frequency band perceivable by a human sensory organ on the operation surface when the vibrating element is driven for a predetermined time.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a perspective view illustrating an electronic device according to an embodiment;

FIG. 2 is a plan view illustrating the electronic device according to the embodiment;

FIG. 3 is a diagram illustrating a cross section with arrows taken along line A-A of the electronic device illustrated in FIG. 2;

FIGS. 4A and 4B are diagrams illustrating a wavefront, which is formed in parallel to the short side of a top panel, of a standing wave generated in the top panel by natural vibration in the ultrasonic band;

FIGS. 5A and 5B are diagrams for describing a state in which a dynamic friction force applied to a fingertip performing operational input changes due to the natural vibration in the ultrasonic band generated in the top panel of the electronic device;

FIG. 6 is a diagram illustrating a configuration of the electronic device according to the embodiment;

FIG. 7 is a table illustrating data to be stored in a memory;

FIG. 8 is a table illustrating data to be stored in a memory;

FIG. 9 is a diagram illustrating waveforms of a first drive signal and a second drive signal for driving a vibrating element in a vibration pattern that provides a click feeling in response to a pressing operation;

FIG. 10 is a flowchart illustrating processing executed by a drive control unit of a drive control device of the electronic device according to the embodiment;

FIG. 11 is a diagram illustrating the frequency characteristic of the conductance of the vibrating element;

FIG. 12 is a diagram illustrating the frequency characteristic of displacement of the surface of the top panel;

FIG. 13 is a diagram illustrating the frequency characteristic of the conductance of the vibrating element;

FIG. 14 is a diagram illustrating the frequency characteristic of displacement of the surface of the top panel;

FIG. 15 is a diagram illustrating the dependence of the characteristic of the natural frequency (resonance frequency) regarding the length of the top panel on the thickness of a top panel 120;

FIG. 16 is a diagram illustrating the dependence of the characteristic of the natural frequency (resonance frequency) regarding the length of the top panel on the thickness of the top panel 120;

FIG. 17 is a diagram illustrating the dependence of the characteristic of the natural frequency (resonance frequency) regarding the length of the top panel on the thickness of the top panel 120;

FIG. 18 is a diagram illustrating waveforms of the first drive signal and the second drive signal for providing a click feeling;

FIG. 19 is a diagram illustrating waveforms of the first drive signal and the second drive signal for providing a click feeling;

FIG. 20 is a diagram illustrating waveforms of the first drive signal and the second drive signal for providing a click feeling;

FIG. 21 is a diagram illustrating waveforms of the first drive signal and the second drive signal for providing a click feeling;

FIG. 22 is a diagram illustrating waveforms of the first drive signal and the second drive signal for providing a click feeling;

FIG. 23 is a diagram illustrating the periphery of a driver's seat in a vehicle;

FIG. 24 is a diagram illustrating a cross section with arrows taken along line A-A of an electronic device according to a modification of the embodiment;

FIG. 25 is a diagram illustrating an electronic device according to a second modification of the embodiment;

FIG. 26 is a diagram illustrating a cross section of a touch pad of an electronic device according to a third modification of the embodiment; and

FIG. 27 is a plan view illustrating an operating state of an electronic device according to a modification of the embodiment.

### DESCRIPTION OF EMBODIMENTS

For example, the input device includes an input unit that accepts an input by pressing, a load detection unit that detects a pressing load on the input unit, and a vibration unit that vibrates the input unit. The input device is characterized by further including a control unit that controls driving of the vibration unit so as to generate a force to levitate a pressing object pressing the input unit, when the pressing load detected by the load detection unit satisfies a predetermined criterion for accepting an input to the input unit.

For example, the input device controls the driving of the vibration unit so as to generate a force to levitate a pressing object pressing the input unit. However, since there is only one type of vibration, it may be difficult to provide a good tactile sensation.

In view of the foregoing, a drive control device, an electronic device, and a drive control method capable of providing a favorable tactile sensation may be provided.

Hereinafter, embodiments of a drive control device, an electronic device, and a drive control method will be described.

### EMBODIMENT

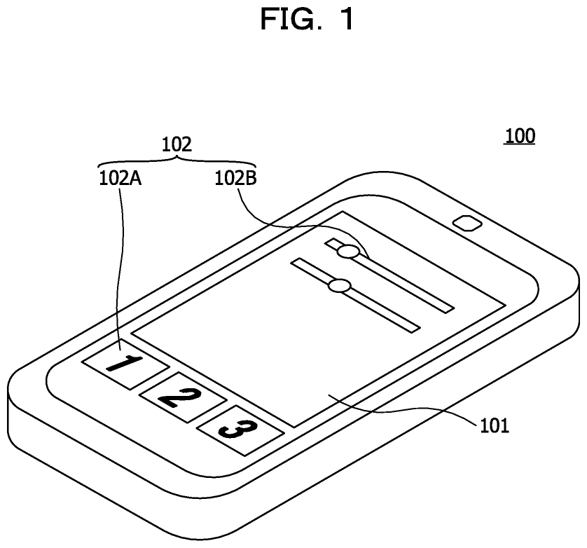

FIG. 1 is a perspective view illustrating an electronic device 100 according to an embodiment.

The electronic device 100 is a smartphone terminal having a touch panel as an input operation unit, for example. Here, a mode in which the electronic device 100 is a smartphone terminal will be described. However, the electronic device 100 is not limited to a smartphone terminal, as long as it is a device having a touch panel as an input operation unit. Alternatively, the electronic device 100 may be a handheld terminal such as a tablet computer or a game machine, for example. Additionally, the electronic device 100 may be, for example, a device arranged inside or outside a vehicle such as a passenger vehicle or a commercial vehicle. Additionally, the electronic device 100 may be a device installed and used at a specific place such as an automatic teller machine (ATM), for example.

The electronic device 100 includes an input operation unit 101 in which a display panel is disposed below the touch panel, and various buttons 102A, sliders 102B, or the like using a graphic user interface (GUI) (hereinafter referred to as GUI operation unit 102) are displayed on the display panel.

A user of the electronic device 100 normally touches the input operation unit 101 with his/her fingertip to operate the GUI operation unit 102.

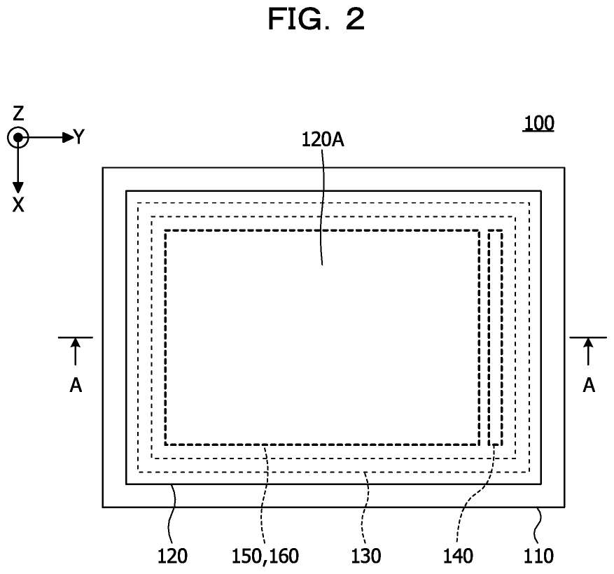

Next, a specific configuration of the electronic device 100 will be described with reference to FIG. 2.

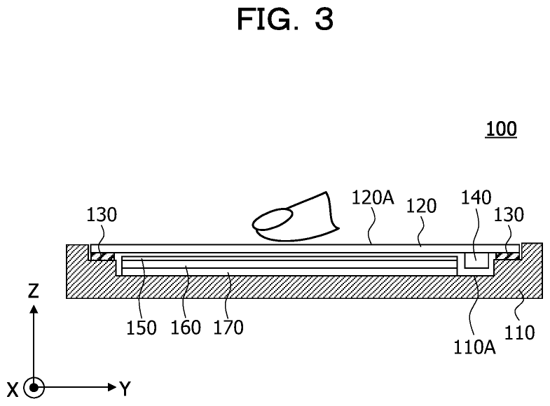

FIG. 2 is a plan view illustrating the electronic device 100 according to the embodiment, and FIG. 3 is a diagram illustrating a cross section with arrows taken along line A-A of the electronic device 100 illustrated in FIG. 2. Note that an XYZ coordinate system, which is an orthogonal coordinate system, is defined as illustrated in FIGS. 2 and 3.

The electronic device 100 includes a housing 110, a top panel 120, double-sided tape 130, a vibrating element 140, a touch panel 150, a display panel 160, and a substrate 170.

The housing 110 is made of resin, for example, and as illustrated in FIG. 3, has the substrate 170, the display panel 160, and the touch panel 150 disposed in a recess 110A. The top panel 120 is bonded to the housing 110 by the double-sided tape 130.

The top panel 120 is a thin plate-shaped member that is rectangular in plan view, and is made of transparent glass or reinforced plastic such as polycarbonate. A surface 120A (surface on positive Z-axis direction side) of the top panel 120 is an example of an operation surface on which the user of the electronic device 100 performs operational input. Operational input refers to a state where the user touches the top panel 120 with his/her fingertip to perform input to the electronic device 100. Note that input using a tool that can operate the touch panel 150 such as a stylus pen instead of the fingertip is also included in operational input.

The vibrating element 140 is bonded to a surface of the top panel 120 on the negative Z-axis direction side, and four sides of the top panel 120 in plan view are bonded to the housing 110 by the double-sided tape 130. Note that the double-sided tape 130 only needs to be capable of bonding the four sides of the top panel 120 to the housing 110, and does not need to be a rectangular loop as illustrated in FIG. 3.

The touch panel 150 is disposed on the negative Z-axis direction side of the top panel 120. The top panel 120 is provided to protect a surface of the touch panel 150. Note that another panel, protective film, or the like may be further provided on the surface 120A of the top panel 120.

In the state where the vibrating element 140 is bonded to the surface of the top panel 120 on the negative Z-axis direction side, the top panel 120 vibrates when the vibrating element 140 is driven by a first drive signal or a second drive signal output from a drive control unit described later.

In the embodiment, by driving the vibrating element 140 by the first drive signal, the top panel 120 is vibrated at the natural frequency (resonance frequency) of the ultrasonic band of the top panel 120 to generate a standing wave in the top panel 120.

Additionally, in the embodiment, by driving the vibrating element 140 with the second drive signal, the top panel 120 is vibrated at a natural frequency (resonance frequency) of the top panel 120 in a frequency band perceivable by the human sensory organ to generate a standing wave in the top panel 120. This natural frequency (resonance frequency) is different from the natural frequency (resonance frequency) of the ultrasonic band.

Since the vibrating element 140 is bonded to the top panel 120, in reality, it is preferable to determine two types of natural frequencies (resonance frequencies) in consideration of the weight of the vibrating element 140, and the like.

The vibrating element 140 is bonded to the surface of the top panel 120 on the negative Z-axis direction side, along the short side extending in the X-axis direction on the positive Y-axis direction side. The vibrating element 140 only needs to be an element capable of generating vibration in the ultrasonic band, and an element including a piezoelectric element may be used, for example.

The vibrating element 140 is driven by a first drive signal output from the drive control unit described later. The amplitude (intensity) and frequency of vibration generated by the vibrating element 140 are set by the first drive signal. Additionally, on/off of the vibrating element 140 is controlled by the first drive signal.

Note that the ultrasonic band refers to a frequency band of about 20 kHz or more, for example. In the electronic device 100 according to the embodiment, the frequency at which the vibrating element 140 vibrates is equal to the frequency of the top panel 120. Hence, the vibrating element 140 is driven by the first drive signal to vibrate at the natural frequency of the top panel 120.

Additionally, the vibrating element 140 is sometimes driven by a second drive signal. In this case, the amplitude (intensity) and frequency of vibration generated by the vibrating element 140 are set by the second drive signal, and on/off of the vibrating element 140 is controlled by the second drive signal. In the case where the vibrating element 140 is driven by the second drive signal, natural vibration in a vibration mode different from the case where the vibrating element 140 is driven by the first drive signal is generated in the top panel 120.

The touch panel 150 is disposed above the display panel 160 (positive Z-axis direction side) and below the top panel 120 (negative Z-axis direction side). The touch panel 150 is an example of a coordinate detection unit that detects a position (hereinafter referred to as operational input position) where the user of the electronic device 100 touches the top panel 120.

Various buttons and the like using the GUI (hereinafter referred to as GUI operation unit) are displayed on the display panel 160 below the touch panel 150. Hence, the user of the electronic device 100 normally touches the top panel 120 with his/her fingertip to operate the GUI operation unit.

The touch panel 150 only needs to be a coordinate detection unit capable of detecting the operational input position on the top panel 120 by the user, and only needs to be a capacitive or resistive coordinate detection unit, for example. Here, a mode in which the touch panel 150 is a capacitive coordinate detection unit will be described. The capacitive touch panel 150 can detect operational input to the top panel 120 even if there is a gap between the touch panel 150 and the top panel 120.

Additionally, although a mode in which the top panel 120 is disposed on the input surface side of the touch panel 150 will be described here, the top panel 120 may be integrated with the touch panel 150. In this case, the surface of the touch panel 150 serves as the surface of the top panel 120 illustrated in FIGS. 2 and 3, which constitutes an operation surface. Additionally, the top panel 120 illustrated in FIGS. 2 and 3 may be omitted from the configuration. In this case as well, the surface of the touch panel 150 constitutes an operation surface. Additionally, in this case, it is sufficient if the member having the operation surface is vibrated by the natural vibration of the member.

Additionally, in the case where the touch panel 150 is a capacitive coordinate detection unit, the touch panel 150 may be disposed on the top panel 120. In this case as well, the surface of the touch panel 150 constitutes an operation surface. Additionally, in the case where the touch panel 150 is a capacitive coordinate detection unit, the top panel 120 illustrated in FIGS. 2 and 3 may be omitted from the configuration. In this case as well, the surface of the touch panel 150 constitutes an operation surface. Additionally, in this case, it is sufficient if the member having the operation surface is vibrated by the natural vibration of the member.

The display panel 160 only needs to be a display unit capable of displaying an image, such as a liquid crystal display panel and an organic electroluminescence (EL) panel, for example. The display panel 160 is disposed on the substrate 170 (positive Z-axis direction side) using a holder or the like (not illustrated) inside the recess 110A of the housing 110.

The display panel 160 is driven and controlled by a driver integrated circuit (IC) described later, and displays the GUI operation unit, an image, a character, a symbol, a figure, and the like depending on the operation status of the electronic device 100.

The substrate 170 is disposed inside the recess 110A of the housing 110. The display panel 160 and the touch panel 150 are disposed above the substrate 170. The display panel 160 and the touch panel 150 are fixed to the substrate 170 and the housing 110 by a holder or the like (not illustrated).

In addition to the drive control device described later, various circuits and the like necessary to drive the electronic device 100 are mounted on the substrate 170.

In the electronic device 100 having a configuration as described above, when the user touches the top panel 120 with his/her finger and the movement of the fingertip is detected, the drive control unit mounted on the substrate 170 drives the vibrating element 140 and vibrates the top panel 120 at the frequency in the ultrasonic band. The frequency in the ultrasonic band is a resonance frequency of a resonance system including the top panel 120 and the vibrating element 140, which generates a standing wave in the top panel 120.

By generating a standing wave in the ultrasonic band along with the movement of the user's fingertip, the electronic device 100 provides a tactile sensation to the user through the top panel 120.

Additionally, the electronic device 100 is configured such that when the user wants to confirm a desired operation content, he/she can perform an operational input of pressing the top panel 120 to confirm the operation content. In a case where such a pressing operational input is performed, the electronic device 100 drives the vibrating element 140 in the following manner to allow the user to sense, by a tactile sensation, that the operation content has been confirmed.

When an operational input of pressing the top panel 120 is performed in a state where the user's fingertip is touching the top panel 120 and is stationary, the electronic device 100 first drives the vibrating element 140 with the first drive signal for a predetermined first short time to reduce the dynamic friction force applied to the fingertip, and then drives the vibrating element 140 with the second drive signal for a predetermined second short time. This provides a tactile sensation simulating a tactile sensation received when a mechanical button such as a metal dome button is pressed. The predetermined first short time and the predetermined second short time are very short times of 100 milliseconds or less, for example.

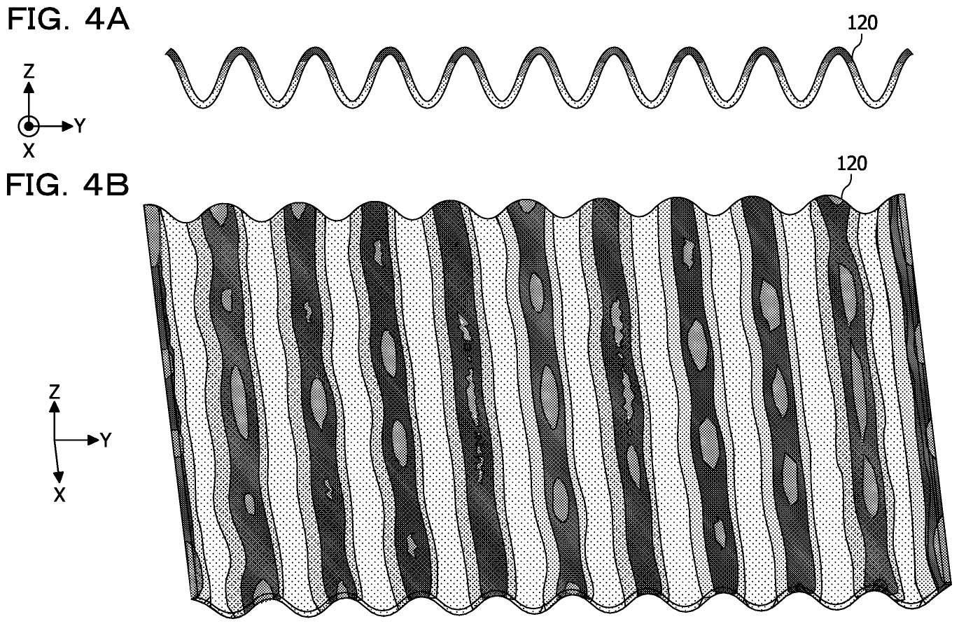

Next, the standing wave to be generated in the top panel 120 will be described with reference to FIGS. 4A and 4B.

FIGS. 4A and 4B are diagrams illustrating a wavefront, which is formed in parallel to the short side of the top panel 120, of the standing wave generated in the top panel 120 by natural vibration in the ultrasonic band. FIG. 4A is a side view, and FIG. 4B is a perspective view. FIGS. 4A and 4B illustrate a standing wave in the ultrasonic band generated in the top panel 120 in the case where the vibrating element 140 is driven with the first drive signal. In FIGS. 4A and 4B, XYZ coordinates similar to those in FIGS. 2 and 3 are defined. Note that FIGS. 4A and 4B illustrate the amplitude of the standing wave in an exaggerated manner for easy understanding. In addition, the vibrating element 140 is omitted from FIGS. 4A and 4B.

A natural frequency (resonance frequency) f of the top panel 120 is expressed by the following formulae (1) and (2) using Young's modulus E, a density ρ, Poisson's ratio δ, a long side dimension l, and a thickness t of the top panel 120, and the number of cycles k of the standing wave existing in the long side direction. Since the standing wave has the same waveform in units of ½ cycle, the number of cycles k takes values in increments of 0.5, which is 0.5, 1, 1.5, 2, and so on.

$$\begin{matrix}[ Expression 1 ] & \\ f = \frac{π {k}^{2} t}{{l}^{2}} \sqrt{\frac{E}{3 ρ ( 1 - {δ}^{2} )}} \\ & ( 1 ) \\ [ Expression 2 ] & \\ f = α {k}^{2} & ( 2 )\end{matrix}$$

Note that a coefficient α in formula (2) is a collective expression of coefficients other than k² in formula (1).

The standing wave illustrated in FIGS. 4A and 4B is an exemplar waveform in a case where the number of cycles k is 10. In a case where Gorilla (registered trademark) glass having a long side length l of 142 mm, a short side length of 80 mm, and a thickness t of 0.7 mm is used as the top panel 120, for example, a natural frequency f is 30 kHz in a case where the number of cycles k is 10. In this case, a first drive signal having a frequency of 30 kHz may be used.

The top panel 120 is a plate-shaped member, and when the vibrating element 140 (see FIGS. 2 and 3) is driven to generate the natural vibration in the ultrasonic band, the top panel 120 is bent as illustrated in FIGS. 4A and 4B, thereby generating a standing wave in the surface 120A.

Note that, although the description herein is given of a mode in which one vibrating element 140 is bonded along the short side extending in the X-axis direction on the positive Y-axis direction side on the surface of the top panel 120 on the negative Z-axis direction side, two vibrating elements 140 may be used. In the case of using two vibrating elements 140, it is sufficient if the other one of the vibrating elements 140 is bonded to the surface of the top panel 120 on the negative Z-axis direction side along the short side extending in the X-axis direction on the negative Y-axis direction side. In this case, it is sufficient if the two vibrating elements 140 are disposed to be axially symmetric with a center line parallel to the two short sides of the top panel 120 serving as a symmetry axis.

Additionally, in the case of driving the two vibrating elements 140, it is sufficient that the two vibrating elements 140 be driven in the same phase if the number of cycles k is an integer, and the two vibrating elements 140 be driven in opposite phases if the number of cycles k is a decimal (number including integer part and decimal part).

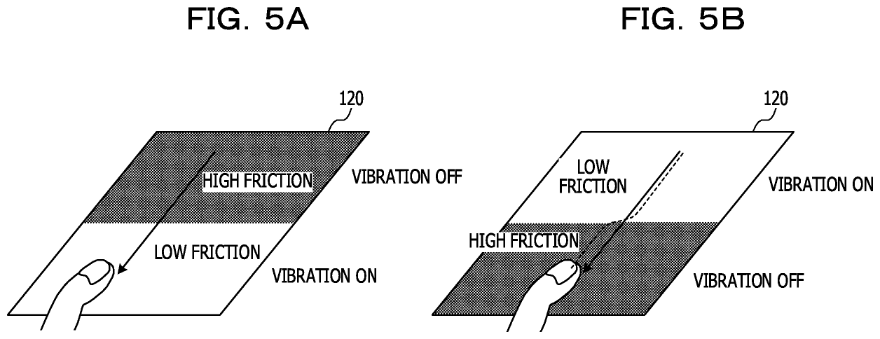

Next, the natural vibration in the ultrasonic band generated in the top panel 120 of the electronic device 100 will be described with reference to FIGS. 5A and 5B.

FIGS. 5A and 5B are diagrams for describing a state in which a dynamic friction force applied to a fingertip performing operational input changes due to the natural vibration in the ultrasonic band generated in the top panel 120 of the electronic device 100. In FIGS. 5A and 5B, the user is performing, while touching the top panel 120 with his/her fingertip, operational input of moving the finger along an arrow from the back side to the front side of the top panel 120. Note that the vibration is turned on/off by turning on/off the vibrating element 140 (see FIGS. 2 and 3).

Additionally, in FIGS. 5A and 5B, in the depth direction of the top panel 120, the range that the finger touches while the vibration is turned off is illustrated in gray, and the range that the finger touches while the vibration is turned on is illustrated in white.

While the natural vibration in the ultrasonic band is generated over the entire top panel 120 as illustrated in FIGS. 4A and 4B, FIGS. 5A and 5B illustrate operation patterns of switching on/off the vibration while the user's finger moves from the back side to the front side of the top panel 120.

Hence, in FIGS. 5A and 5B, in the depth direction of the top panel 120, the range that the finger touches while the vibration is turned off is illustrated in gray, and the range that the finger touches while the vibration is turned on is illustrated in white.

In the operation pattern illustrated in FIG. 5A, the vibration is turned off when the user's finger is at the back side of the top panel 120, and the vibration is turned on as the finger is moved to the front side.

On the other hand, in the operation pattern illustrated in FIG. 5B, the vibration is turned on when the user's finger is at the back side of the top panel 120, and the vibration is turned off as the finger is moved to the front side.

Here, when the natural vibration in the ultrasonic band is generated in the top panel 120, an air layer due to the squeeze effect is interposed between the surface 120A of the top panel 120 and the finger, and a dynamic friction coefficient of when the finger is moved along the surface 120A of the top panel 120 decreases.

Accordingly, in FIG. 5A, the dynamic friction force applied to the fingertip is large in the range illustrated in gray on the back side of the top panel 120, and the dynamic friction force applied to the fingertip is small in the range illustrated in white on the front side of the top panel 120.

Hence, as illustrated in FIG. 5A, when the vibration is turned on, the user who performs operational input to the top panel 120 senses a decrease in the dynamic friction force applied to the fingertip, and perceives ease in sliding the fingertip. At this time, with the surface 120A of the top panel 120 being smoother, the user feels as if a recess exists on the surface 120A of the top panel 120 when the dynamic friction force decreases.

On the other hand, in FIG. 5B, the dynamic friction force applied to the fingertip is small in the range illustrated in white on the back side of the top panel 120, and the dynamic friction force applied to the fingertip is large in the range illustrated in gray on the front side of the top panel 120.

Hence, as illustrated in FIG. 5B, when the vibration is turned off, the user who performs operational input to the top panel 120 senses an increase in the dynamic friction force applied to the fingertip, and perceives difficulty in sliding the fingertip or the feeling that the fingertip is obstructed. Then, since the movement of the fingertip becomes less smooth, it feels as if a projection exists on the surface 120A of the top panel 120 when the dynamic friction force increases.

As described above, the user can feel unevenness with his/her fingertip in the cases of FIGS. 5A and 5B. The fact that humans perceive unevenness in this manner is disclosed in “Shokkan dezainno tameno insatsubutsu tenshahou to Sticky-band Illusion” (Papers of 11th Annual Conference of the Society of Instrument and Control Engineers System Integration Division (SI2010, Sendai), 174-177, 2010-12), for example. Additionally, the fact that humans perceive unevenness in this manner is also disclosed in “Fishbone Tactile Illusion” (Papers of 10th Annual Conference of the Virtual Reality Society of Japan (September 2005)).

Note that, while the description herein has been given of the change in dynamic friction force in the case where on/off of vibration is switched, the same applies to a case where the amplitude (intensity) of the vibrating element 140 is changed.

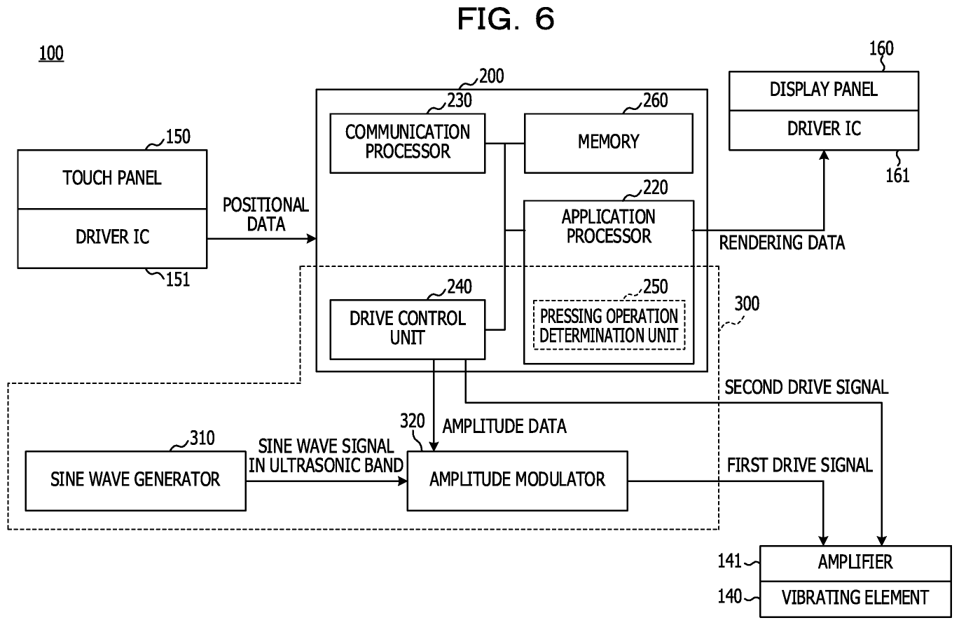

Next, a configuration of the electronic device 100 according to the embodiment will be described with reference to FIG. 6.

FIG. 6 is a diagram illustrating a configuration of the electronic device 100 according to the embodiment.

The electronic device 100 includes the vibrating element 140, an amplifier 141, the touch panel 150, a driver integrated circuit (IC) 151, the display panel 160, a driver IC 161, a control unit 200, a sine wave generator 310, and an amplitude modulator 320.

The control unit 200 includes an application processor 220, a communication processor 230, a drive control unit 240, a pressing operation determination unit 250, and a memory 260. The control unit 200 is implemented by an IC chip, for example. The pressing operation determination unit 250 is included in the application processor 220.

Additionally, the drive control unit 240, the pressing operation determination unit 250, the sine wave generator 310, and the amplitude modulator 320 constitute a drive control device 300. Note that while the description herein is given of a mode in which the application processor 220, the communication processor 230, the drive control unit 240, the pressing operation determination unit 250, and the memory 260 are implemented by the one control unit 200, the drive control unit 240 may be provided separately as another IC chip or processor outside the control unit 200. In this case, it is sufficient if, among data stored in the memory 260, the data necessary for driving and controlling by the drive control unit 240 is stored in a memory different from the memory 260 and provided inside the drive control device 300.

In FIG. 6, the housing 110, the top panel 120, the double-sided tape 130, and the substrate 170 (see FIG. 2) are omitted. Additionally, the description herein will be given of the amplifier 141, the driver IC 151, the driver IC 161, the drive control unit 240, the memory 260, the sine wave generator 310, and the amplitude modulator 320.

The amplifier 141 is disposed between the drive control device 300 and the vibrating element 140, and amplifies the first drive signal output from the drive control device 300 to drive the vibrating element 140.

The driver IC 151 is connected to the touch panel 150, detects positional data indicating a position at which operational input to the touch panel 150 has been performed, and outputs the positional data to the control unit 200. As a result, the positional data is input into the application processor 220 and the drive control unit 240. Note that inputting positional data to the drive control unit 240 is equivalent to inputting positional data to the drive control device 300.

The driver IC 161 is connected to the display panel 160, inputs rendering data output from the drive control device 300 to the display panel 160, and causes the display panel 160 to display an image based on the rendering data. Thus, a GUI operation unit, an image, or the like based on the rendering data is displayed on the display panel 160.

The application processor 220 has an operating system (OS) of the electronic device 100 installed therein, and performs processing for executing various applications of the electronic device 100. The application processor 220 includes the pressing operation determination unit 250. Additionally, the application processor 220 is an example of an operation determination unit that determines whether an operational input to the GUI operation unit has been performed on the basis of the positional data input from the touch panel 150 and the display content of the application being executed.

The communication processor 230 executes processing necessary for the electronic device 100 to perform communication such as 3rd generation (3G), 4th generation (4G), long term evolution (LTE), and Wi-Fi.

When providing a tactile sensation using the squeeze effect, the drive control unit 240 outputs amplitude data to the amplitude modulator 320 in a case where two predetermined conditions are met. Tactile sensation using the squeeze effect is a tactile sensation provided to the user's fingertip when the user's fingertip is moved along the surface 120A of the top panel 120.

Amplitude data is data indicating an amplitude value for adjusting the strength of the first drive signal used for driving the vibrating element 140 when providing a tactile sensation using the squeeze effect. For example, amplitude data is digital data indicating the amplitude value for adjusting the strength of the first drive signal at the frequency of 350 Hz. The drive control unit 240 that drives the vibrating element 140 with the first drive signal is an example of a first drive control unit.

The amplitude value is set according to the degree of temporal change in positional data. Here, as the degree of temporal change in positional data, a speed at which the user's fingertip moves along the surface 120A of the top panel 120 is used. The moving speed of the user's fingertip is calculated by the drive control unit 240 on the basis of the degree of temporal change in the positional data input from the driver IC 151.

Additionally, the drive control device 300 according to the embodiment vibrates the top panel 120 to change the dynamic friction force applied to the user's fingertip when the fingertip is moved along the surface 120A of the top panel 120. Since the dynamic friction force is generated during the movement of the fingertip, the drive control unit 240 vibrates the vibrating element 140 when the moving speed becomes equal to or higher than a predetermined threshold speed. The moving speed becoming equal to or higher than the predetermined threshold speed is the first predetermined condition.

Accordingly, the amplitude value indicated by the amplitude data output from the drive control unit 240 is zero when the moving speed is lower than the predetermined threshold speed, and is set to a predetermined amplitude value representing a tactile sensation when the moving speed becomes equal to or higher than the predetermined threshold speed.

Additionally, the drive control device 300 according to the embodiment outputs amplitude data to the amplitude modulator 320 in a case where the position of the fingertip that performs operational input is within a predetermined area where vibration is to be generated. The position of the fingertip that performs operational input being within the predetermined area where vibration is to be generated is the second predetermined condition.

Whether the position of the fingertip that performs operational input is within the predetermined area where vibration is to be generated is determined on the basis of whether or not the position of the fingertip that performs operational input is inside the predetermined area where vibration is to be generated.

Here, a position on the display panel 160, such as the GUI operation unit, an area for displaying an image, and an area representing the entire page to be displayed on the display panel 160, is specified by area data indicating the area. The area data exists for all GUI operation units, areas for displaying an image, or areas representing the entire page displayed on the display panel 160 in all applications.

Hence, when it is determined, as the second predetermined condition, whether the position of the fingertip that performs operational input is within the predetermined area where vibration is to be generated, the type of the application being activated by the electronic device 100 has an effect on the determination. This is because the display on the display panel 160 differs depending on the type of the application.

Additionally, it is because the type of operational input of moving the fingertip touching the surface 120A of the top panel 120 differs depending on the type of the application. As a type of operational input of moving the fingertip touching the surface 120A of the top panel 120, when operating the GUI operation unit, there is what is called a flick operation, for example. A flick operation is an operation of moving the fingertip along the surface 120A of the top panel 120 for a relatively short distance in a manner of flicking the surface.

The drive control unit 240 determines, using the area data, whether or not the position indicated by the positional data input from the driver IC 151 is inside the predetermined area where vibration is to be generated.

Data to be stored in the memory 260, in which data indicating the type of application, area data indicating the GUI operation unit or the like on which operational input is made, and pattern data indicating a vibration pattern are associated with one another, is stored in the memory 260.

The two predetermined conditions necessary for outputting amplitude data to the amplitude modulator 320 when the drive control unit 240 provides a tactile sensation using the squeeze effect are the moving speed of the fingertip being equal to or higher than the predetermined threshold speed, and coordinates representing the position of the operational input being inside the predetermined area where vibration is to be generated.

When providing a tactile sensation using the squeeze effect, the drive control unit 240 reads amplitude data indicating the amplitude value from the memory 260 and outputs the amplitude data to the amplitude modulator 320, in a case where the moving speed of the fingertip is equal to or higher than the predetermined threshold speed, and the coordinates of the operational input are inside the predetermined area where vibration is to be generated.

Additionally, the drive control unit 240 drives the vibrating element 140 with the second drive signal for providing a tactile sensation having a click feeling, when the pressing operation determination unit 250 determines that an operation of pressing the surface 120A of the top panel 120 has been performed in a display area of a predetermined GUI operation unit. The drive control unit 240 that drives the vibrating element 140 with the second drive signal is an example of a second drive control unit.

The second drive signal is a drive signal that generates, in the surface 120A of the top panel 120, vibration whose amplitude increases with the passage of time and in a frequency band perceivable by the human sensory organ. The frequency of the second drive signal is 350 Hz.

Note that the human sensory organ mainly includes Meissner's corpuscles and Pacinian corpuscles. Meissner's corpuscles and Pacinian corpuscles exist in the human skin and are sensory organs that sense tactile sensation. Tactile sensation sensed by the human skin is mainly sensed by the Meissner's corpuscles and the Pacinian corpuscles.

Meissner's corpuscles have a sensitivity at about 100 Hz or less, and have a characteristic that a tactile sensation at about 30 Hz is most easily perceived. Additionally, Pacinian corpuscles have a sensitivity in a band of about 30 Hz to about 500 Hz, and have a characteristic that a tactile sensation at about 200 Hz is most easily perceived.

The pressing operation determination unit 250 is included in the application processor 220. The pressing operation determination unit 250 represents part of functions implemented by the OS of the application processor 220.

The pressing operation determination unit 250 outputs a pressing event when an operational input (pressing operation) of pressing the top panel 120 is performed in an area where a predetermined GUI operation unit is displayed. The pressing operation determination unit 250 determines whether the pressing operation has been performed by determining whether the area detected by the touch panel 150 when the user's fingertip is touching the top panel 120 is equal to or larger than a predetermined area.

A pressing event is a signal indicating that the operation of pressing the top panel 120 has been performed in an area where a predetermined GUI operation unit is displayed. Additionally, a predetermined GUI operation unit is a GUI operation unit that receives a pressing operation such as a GUI operation portion representing an image of a button, for example. An area where a predetermined GUI operation portion is displayed an area where a GUI operation unit that receives the pressing operation is displayed, like a GUI operation unit representing an image of a button.

The pressing event is used when the application processor 220 executes the various applications of the electronic device 100, and is also input to the drive control unit 240 and used when the drive control unit 240 drives the vibrating element 140 with the second drive signal.

The memory 260 stores data in which data indicating the type of application, area data indicating the GUI operation unit or the like on which operational input is made, and pattern data indicating a vibration pattern are associated with one another. The vibration pattern will be described later. Additionally, the memory 260 stores data indicating the amplitude and frequency of the second drive signal.

Additionally, the memory 260 stores data and programs necessary for the application processor 220 to execute an application, data and programs necessary for the communication processor 230 to perform communication processing, and the like.

The sine wave generator 310 generates a sine wave necessary for generating the first drive signal for vibrating the top panel 120 at the natural frequency. For example, in a case where the top panel 120 is vibrated at the natural frequency f of 30 kHz, the frequency of the sine wave is 30 kHz. The sine wave generator 310 inputs a sine wave signal in the ultrasonic band to the amplitude modulator 320.

The sine wave signal generated by the sine wave generator 310 is an alternating reference signal to be a basis of the first drive signal for generating the natural vibration in the ultrasonic band, and has a constant frequency and a constant phase. The sine wave generator 310 inputs a sine wave signal in the ultrasonic band to the amplitude modulator 320.

Note that, although the description herein is given of a mode using the sine wave generator 310 that generates a sine wave signal, the signal need not be a sine wave signal. For example, a signal having a waveform in which the rising and falling waveforms of the clock are blunted may be used. Hence, a signal generator that generates an alternating-current signal in the ultrasonic band may be used instead of the sine wave generator 310.

The amplitude modulator 320 modulates the amplitude of the sine wave signal input from the sine wave generator 310 using the amplitude data input from the drive control unit 240, and generates the first drive signal. The amplitude modulator 320 modulates only the amplitude of the sine wave signal in the ultrasonic band input from the sine wave generator 310, and generates the first drive signal without modulating the frequency and the phase.

Hence, the first drive signal output from the amplitude modulator 320 is a sine wave signal in the ultrasonic band obtained by modulating only the amplitude of the sine wave signal in the ultrasonic band input from the sine wave generator 310. Note that the amplitude of the first drive signal is zero in the case where the amplitude data is zero. This is equivalent to a state in which the amplitude modulator 320 does not output a drive signal. Further, the first drive signal is not generated at the same time, and any one of them is generated according to the state of operational input.

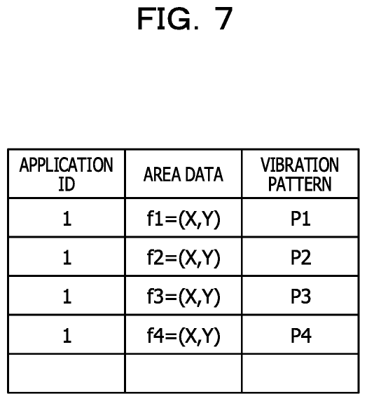

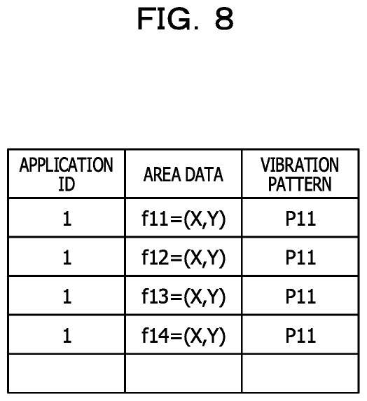

Next, data to be stored in the memory 260 will be described with reference to FIGS. 7 and 8. FIGS. 7 and 8 are tables illustrating data to be stored in the memory 260.

The data illustrated in FIG. 7 is data in which data indicating the type of application, area data indicating a coordinate value of an area where the GUI operation unit or the like on which operational input is made is displayed, and pattern data indicating a vibration pattern are associated with one another.

The vibration pattern illustrated in FIG. 7 is a vibration pattern used for vibrating the vibrating element 140 when the user moves his/her fingertip touching the top panel 120, and is used for generating the first drive signal. A vibration pattern is pattern data in which amplitude data used for generating the first drive signal is arrayed in time series. Amplitude data is arrayed at 350 Hz in a time axis direction, for example.

The vibration pattern illustrated in FIG. 7 is a vibration pattern used for providing a tactile sensation by reducing the dynamic friction coefficient applied to the fingertip moved along the surface 120A of the top panel 120 using the squeeze effect, and changing the intensity of the vibration.

FIG. 7 illustrates an application identification (ID) as data indicating the type of application. Additionally, formulae f1 to f4 representing a coordinate value of the area where the GUI operation unit or the like on which operational input is made is displayed are illustrated as area data. Additionally, P1 to P4 are illustrated as pattern data indicating a vibration pattern.

Note that the application indicated by the application ID included in the data stored in the memory 260 includes all of applications that can be used on a smartphone terminal, and also includes an email editing mode.

Additionally, FIG. 8 illustrates data in which data indicating the type of application, area data indicating a coordinate value of an area where the GUI operation unit or the like on which operational input is made is displayed, and pattern data indicating a vibration pattern are associated with one another.

The vibration pattern illustrated in FIG. 8 is a vibration pattern used for vibrating the vibrating element 140 when the user performs a pressing operation on the top panel 120 in a display area of a predetermined GUI operation unit, and is used for generating the first drive signal. The vibration pattern illustrated in FIG. 8 is pattern data in which amplitude data is arrayed in time series, and is arrayed at 30 kHz in the time axis direction, for example. The amplitude of the vibration pattern illustrated in FIG. 8 is constant.

The first drive signal generated by the vibration pattern illustrated in FIG. 8 is used in combination with the second drive signal when a pressing operation is performed.

Specifically, when a pressing operation is performed on the top panel 120, the drive control unit 240 drives the vibrating element 140 for 75 ms with the first drive signal, and then drives the vibrating element 140 for 30 ms with the second drive signal, for example.

By driving the vibrating element 140 with the first drive signal and the second drive signal in this manner, a click feeling received on the fingertip when a metal dome button is pressed is simulated.

Such a click feeling can be realized by driving a linear resonant actuator (LRA) with a drive signal having a frequency perceivable by the human sensory organ, for example.

However, if the tactile sensation having a click feeling can be provided by vibration of the vibrating element 140, adding an actuator such as an LRA becomes unnecessary. In particular in a case where the electronic device 100 is a portable terminal device, for example, increasing the number of components is not realistic from the viewpoint of space constraints and the like. Hence, the electronic device 100 provides the tactile sensation having a click feeling by driving the vibrating element 140 with the first drive signal and the second drive signal.

FIG. 8 illustrates application identification (ID) as data indicating the type of application. Additionally, formulae f11 to f14 representing a coordinate value of the area where the GUI operation unit or the like on which operational input is made is displayed are illustrated as area data. Additionally, P11 is illustrated as pattern data indicating a vibration pattern used to provide a click feeling. The vibration pattern P11 used to provide a click feeling is a pattern whose amplitude increases with the passage of time. Note that the application ID is similar to the application ID illustrated in FIG. 7.

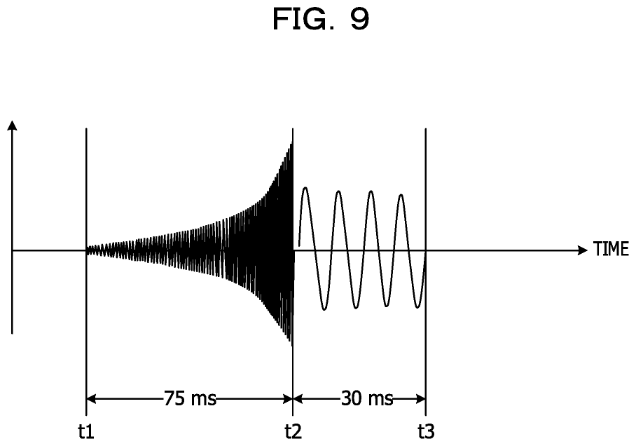

FIG. 9 is a diagram illustrating waveforms of the first drive signal and the second drive signal that drive the vibrating element 140 in a vibration pattern that provides a click feeling in response to a pressing operation. In FIG. 9, the horizontal axis represents time, and the vertical axis represents amplitude.

When the pressing operation is performed at time t1, the drive control unit 240 drives the vibrating element 140 with the first drive signal. The frequency of the first drive signal is 30 kHz, and the amplitude of the first drive signal based on the vibration pattern that provides a click feeling in response to a pressing operation increases nonlinearly with the passage of time. The vibrating element 140 is driven by the first drive signal based on the vibration pattern that provides a click feeling in response to a pressing operation for 75 ms. Note that time t1 is a time at which the pressing operation determination unit 250 determines that the area detected by the touch panel 150 is equal to or larger than a predetermined area.

While the vibrating element 140 is driven by the first drive signal based on the vibration pattern that provides a click feeling in response to a pressing operation, a natural vibration in the ultrasonic band is generated on the surface 120A of the top panel 120, and an air layer due to the squeeze effect is generated between the fingertip and the surface 120A, making the user's fingertip move smoothly.

Since the amplitude of the first drive signal increases nonlinearly with the passage of time from time t1, the displacement of the surface 120A increases nonlinearly. Additionally, when the amplitude of the first drive signal increases nonlinearly, the air layer becomes thicker, and the frictional force applied to the fingertip decreases, so that the pressing force decreases nonlinearly.

At this time, the user presses the fingertip without moving the fingertip in the plane direction of the surface 120A. However, the since frictional force is reduced and the fingertip moves smoothly, the fingertip may be slightly displaced in the plane direction.

At time t2, drive control unit 240 drives the vibrating element 140 with the second drive signal. The frequency of the second drive signal is 350 Hz, which is a frequency included in a frequency band perceivable by the human sensory organ. Since the amplitude of the second drive signal is constant, the second drive signal is a sinusoidal drive signal as illustrated in FIG. 9.

As a result, vibration in a frequency band perceivable by the human sensory organ is generated on the surface 120A of the top panel 120. More specifically, a click impact is transmitted to the user's fingertip, for example.

At time t3, the drive control unit 240 ends the driving of the vibrating element 140 by the second drive signal. The drive control unit 240 drives the vibrating element 140 with the second drive signal for 30 ms.

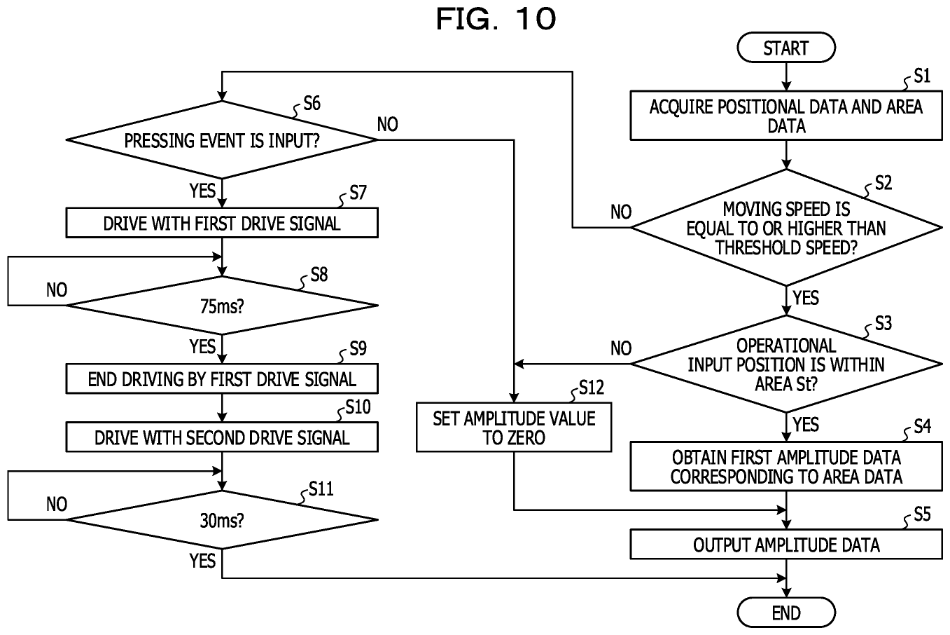

Next, processing executed by the drive control unit 240 of the drive control device 300 of the electronic device 100 according to the embodiment will be described with reference to FIG. 10.

FIG. 10 is a flowchart illustrating processing executed by the drive control unit 240 of the drive control device 300 of the electronic device 100 according to the embodiment.

The OS of the electronic device 100 executes control for driving the electronic device 100 at every predetermined control cycle. Hence, the drive control device 300 performs computing for each predetermined control cycle. The same applies to the drive control unit 240, and the drive control unit 240 repeatedly executes the flow illustrated in FIG. 10 for each predetermined control cycle.

The drive control unit 240 starts the processing when the power of the electronic device 100 is turned on.

The drive control unit 240 acquires area data associated with the vibration pattern for the GUI operation unit on which the current operational input is being made according to the coordinates indicated by the current positional data and the type of the current application (step S1).

The drive control unit 240 determines whether or not the moving speed is equal to or higher than a predetermined threshold speed (step S2). It is sufficient if the moving speed is calculated by vector operation. Note that it is sufficient if the threshold speed is set as the minimum moving speed of the fingertip when performing an operational input while moving the fingertip, such as what is called a flick operation, a swipe operation, and a drag operation. Such a minimum speed may be set on the basis of experimental results, or may be set according to the resolution of the touch panel 150 or the like.

If the drive control unit 240 determines that the moving speed is equal to or higher than the predetermined threshold speed in step S2, the drive control unit 240 determines whether or not the operational input position is within an area St indicated by the area data obtained in step S1 (step S3).

If the drive control unit 240 determines that the operational input position is within the area St indicated by the area data obtained in step S1, the drive control unit 240 obtains amplitude data corresponding to the area data (step S4).

The drive control unit 240 outputs the amplitude data (step S5). Then, the amplitude modulator 320 modulates the amplitude of the sine wave output from the sine wave generator 310 according to the amplitude value of the amplitude data to generate the first drive signal, and the vibrating element 140 is driven.

After finishing the processing in step S5, the drive control unit 240 ends the series of processing (END). While the power of the electronic device 100 is turned on, the drive control unit 240 repeatedly executes the processing from the start to the end.

Additionally, if the drive control unit 240 determines that the moving speed is not equal to or higher than the predetermined threshold speed in step S2 (S2: NO), the drive control unit 240 determines whether the pressing event has been input (step S6). Determining whether the pressing event has been input is determining whether the operation of pressing the top panel 120 has been performed within the area where the predetermined GUI operation unit is displayed.

When determining that the pressing event has been input (S6: YES), the drive control unit 240 drives the vibrating element 140 with the first drive signal of the vibration pattern that provides a click feeling in response to a pressing operation (step S7).

The drive control unit 240 determines whether 75 ms have passed (step S8). The drive control unit 240 repeatedly executes the processing of step S8 until 75 ms have passed.

When determining that 75 ms have passed (S8: YES), the drive control unit 240 ends the driving of the vibrating element 140 by the first drive signal (step S9).

Next, the drive control unit 240 drives the vibrating element 140 with the second drive signal (Step S10). This is to generate vibration in a frequency band perceivable by the human sensory organ on the surface 120A of the top panel 120.

The drive control unit 240 determines whether 30 ms have passed (step S11). The drive control unit 240 repeatedly executes the processing of step S11 until 30 ms have passed.

When determining that 30 ms have passed (S11: YES), the drive control unit 240 ends the series of processing (END). While the power of the electronic device 100 is turned on, the drive control unit 240 repeatedly executes the processing from the start to the end.

Additionally, in step S3, if the drive control unit 240 determines that the operational input position is not within the area St indicated by the area data obtained in step S1 (S3: NO) and, in step S6, if the drive control unit 240 determines that the pressing event has not been input (S6: NO), the drive control unit 240 sets the amplitude value to zero (step S12).

The drive control unit 240 outputs the amplitude data having the amplitude value of zero (step S5). As a result, the drive control unit 240 outputs the amplitude data having the amplitude value of zero, and the amplitude modulator 320 generates a drive signal in which the amplitude of the sine wave output from the sine wave generator 310 is modulated to zero. Hence, the vibrating element 140 is not driven in this case.

Here, how to select the natural frequency of the first drive signal and the natural frequency of the second drive signal will be described. In the electronic device 100, the first drive signal is a drive signal that generates the natural vibration in the ultrasonic band in the top panel 120, and the second drive signal is a drive signal that generates the natural vibration in the frequency band perceivable by the human sensory organ in the top panel 120.

That is, the electronic device 100 selects two of the natural frequencies (resonant frequencies) that can occur in the top panel 120, for example, and uses them for the first drive signal and the second drive signal.

If the top panel 120 is treated as a beam whose both ends in the Y-axis direction are fixed ends, the equation of motion of the beam can be applied. Therefore, a natural frequency (resonance frequency) fr of the top panel 120 can be expressed by the following formula (3). Note that the suffix r of the natural frequency (resonance frequency) fr represents the order of the natural vibration mode.

$$\begin{matrix}[ Expression 3 ] & \\ fr = \frac{1}{4 \sqrt{3} π} \sqrt{\frac{E}{ρ}} {t ( \frac{kr \cdot l}{l} )}^{2} & ( 3 )\end{matrix}$$

In formula (3), p is the density of the material of the top panel 120, E is the Young's modulus of the material of the top panel 120, kr is a variable in the vibration mode of the r-th natural vibration, and l is the length of the top panel 120. Note that the length of the top panel 120 is the length in the direction in which the antinodes and nodes of the natural vibration are arranged, and is therefore the length in the Y-axis direction.

Note, however, that the variable kr needs to satisfy the transcendental equation expressed by formula (4), and is expressed by formula (5).

$$\begin{matrix}[ Expression 4 ] & \\ cos ( kr \cdot l ) cosh ( kr \cdot l ) = 1 & ( 4 ) \\ [ Expression 4 ] & \\ {kr}^{4} = \frac{ρ A ω {r}^{2}}{EI} & ( 5 )\end{matrix}$$

In formula (5), A is the cross-sectional area of the top panel 120, ωr is the angular velocity at the resonance frequency fr, and I is the section modulus of the top panel 120. Note that the cross-sectional area A of the top panel 120 is the area of a cross-section (cross-section cut along XZ plane) in a direction perpendicular to the direction in which antinodes and nodes of natural vibration are arranged, and the section modulus I is a value obtained by multiplying the cross-sectional area A by the square of the thickness of the top panel 120.

The value of the variable kr is determined by selecting the order r of the vibration mode of the natural vibration generated in the top panel 120. Additionally, l included in formula (3) is the length of the top panel 120 in the Y-axis direction.

Hence, by selecting the variable kr used for the first drive signal in the ultrasonic band and the variable kr used for the second drive signal in the frequency band perceivable by the human sensory organ after determining the length l of the top panel 120 in the Y-axis direction, the natural frequency (resonance frequency) fr of the first drive signal and the natural frequency (resonance frequency) fr of the second drive signal can be determined.

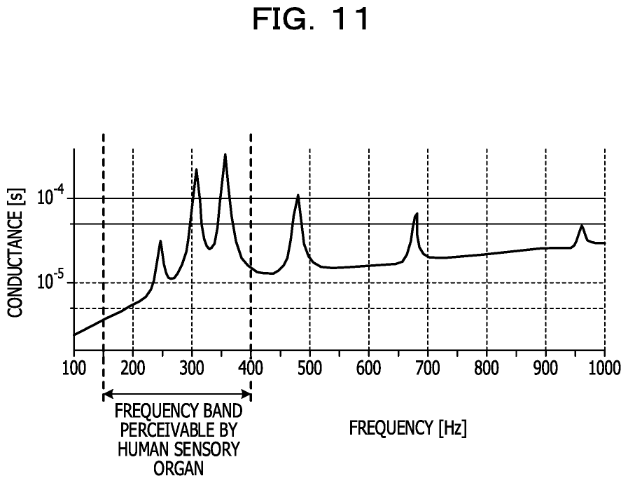

Next, the frequency characteristic of the conductance of the vibrating element 140 and the frequency characteristic of the displacement of the surface 120A of the top panel 120 when the vibrating element 140 is driven will be described with reference to FIGS. 11 to 14. The displacement of the surface 120A is a displacement in the Z-axis direction (see FIGS. 2 and 3). The frequency characteristic is obtained by varying the frequency of the drive signal between 100 Hz and 1000 Hz. Note that the unit of conductance is [s] (siemens).

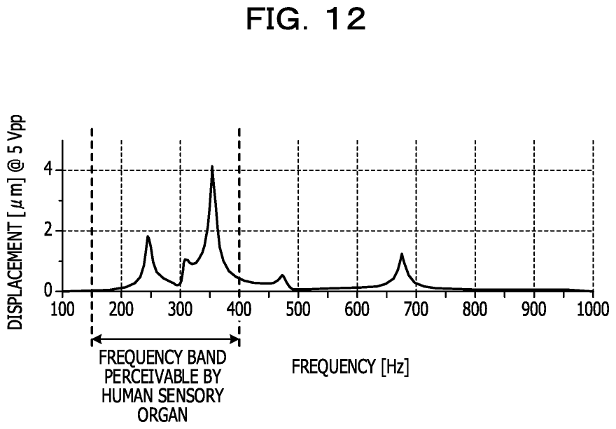

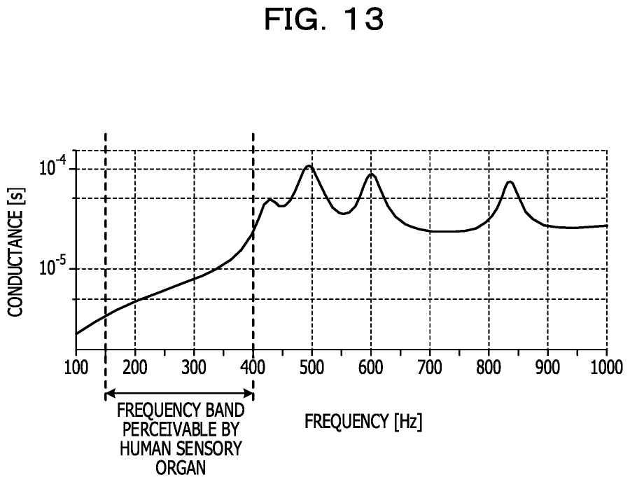

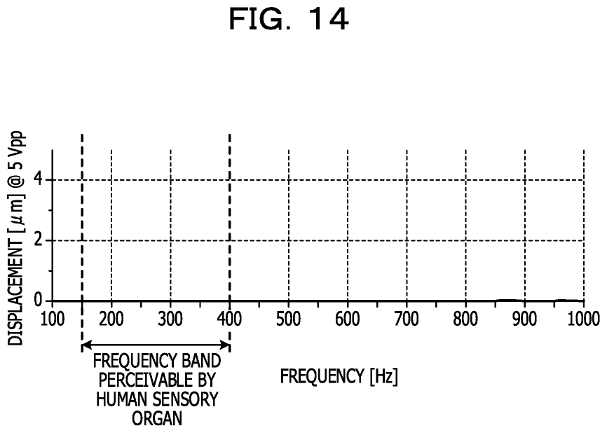

FIGS. 11 and 13 are diagrams illustrating the frequency characteristic of the conductance of the vibrating element 140. FIGS. 12 and 14 are diagrams illustrating the frequency characteristic of displacement of the surface 120A of the top panel 120.

The frequency characteristic of the conductance illustrated in FIGS. 11 and 13 is obtained by varying the frequency of the drive signal for driving the vibrating element 140, and is equivalent to the frequency characteristic obtained by varying the frequency of the second drive signal. Similarly, the frequency characteristic of the displacement of the surface 120A illustrated in FIGS. 12 and 14 is equivalent to the frequency characteristic obtained by varying the frequency of the second drive signal.

Here, the evaluation is made using a frequency band of 150 Hz to 400 Hz as a frequency band perceivable by the human sensory organ. Humans can also sense vibration in a frequency band lower than the frequency band of 150 Hz to 400 Hz and in a frequency band higher than the frequency band of 150 Hz to 400 Hz. However, compared to the frequency band of 150 Hz to 400 Hz, it is difficult to sense vibration in the frequency bands described above unless the vibration intensity is high. That is, the frequency band of 150 Hz to 400 Hz represents the frequency band of vibration that can be easily sensed by humans, for example. Hence, evaluation is made using a frequency band of 150 Hz to 400 Hz as a frequency band perceivable by the human sensory organ.

FIG. 11 illustrates the frequency characteristic of the conductance in a case where the top panel 120 having a length of 142 mm, a width of 78 mm, and a thickness of 0.3 mm is used. As illustrated in FIG. 11, a peak having a high conductance value was obtained between 150 Hz and 400 Hz, which is a frequency band perceivable by the human sensory organ. A high conductance value indicates that the vibrating element 140 is easy to drive.

Peaks of the conductance value were obtained at frequencies of about 250 Hz, about 310 Hz, and about 350 Hz in the frequency band perceivable by the human sensory organ.

As described above, when the vibrating element 140 is driven by using the top panel 120 having a length of 142 mm, a width of 78 mm, and a thickness of 0.3 mm, it has been found that peaks of the conductance value can be obtained in the frequency band perceivable by the human sensory organ.

FIG. 12 illustrates the frequency characteristic of the displacement of the surface 120A in a case where the top panel 120 having a length of 142 mm, a width of 78 mm, and a thickness of 0.3 mm is used. As illustrated in FIG. 12, peaks of displacement of the surface 120A were obtained at about 250 Hz, about 310 Hz, and about 350 Hz in a frequency band perceivable by the human sensory organ.

The highest peak at about 350 Hz was about 4 μm, and the displacement was about 2 μm at about 250 Hz, and about 1 μm at about 310 Hz. Since the amplitude of the vibration needs to be 0.1 μm or more for the human sensory organ to sense the vibration, vibrations of about 250 Hz, about 310 Hz, and about 350 Hz are vibrations perceivable by the human sensory organ.

As described above, when the vibrating element 140 is driven by using the top panel 120 having a length of 142 mm, a width of 78 mm, and a thickness of 0.3 mm, it has been found that a level of displacement of the surface 120A perceivable by the human sensory organ can be obtained in a frequency band perceivable by the human sensory organ.

FIG. 13 illustrates the frequency characteristic of the conductance in a case where the top panel 120 having a length of 142 mm, a width of 78 mm, and a thickness of 0.55 mm is used. As illustrated in FIG. 13, no peak of the conductance value was obtained between 150 Hz and 400 Hz, which is a frequency band perceivable by the human sensory organ.

Peaks of the conductance value were obtained at about 420 Hz, about 500 Hz, about 600 Hz, and about 850 Hz. These frequencies are higher than the frequency band perceivable by the human sensory organ.

As described above, when the vibrating element 140 is driven by using the top panel 120 having a length of 142 mm, a width of 78 mm, and a thickness of 0.55 mm, it has been found that no peak of the conductance can be obtained in the frequency band perceivable by the human sensory organ.

FIG. 14 illustrates the frequency characteristic of the displacement of the surface 120A in a case where the top panel 120 having a length of 142 mm, a width of 78 mm, and a thickness of 0.55 mm is used. As illustrated in FIG. 14, no peak of displacement of the surface 120A was obtained. In order for the human sensory organ to sense vibration, the amplitude of the vibration needs to be 0.1 μm or more, but the displacement of the surface 120A was almost zero.

As described above, when the vibrating element 140 is driven by using the top panel 120 having a length of 142 mm, a width of 78 mm, and a thickness of 0.55 mm, it has been found that no displacement of the surface 120A perceivable by the human sensory organ can be obtained in a frequency band perceivable by the human sensory organ.

From the frequency characteristics illustrated in FIGS. 11 to 14, it has been found that a thickness of 0.3 mm of the top panel 120 is preferable to a thickness of 0.55 mm of the top panel 120.

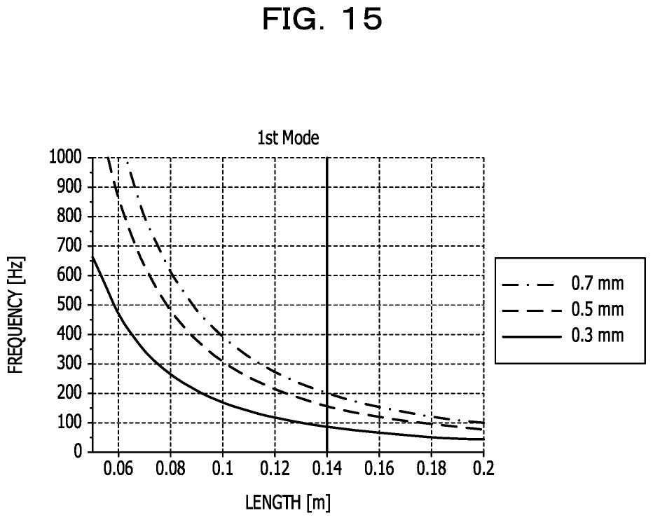

Next, the dependence of the frequency characteristic regarding the length of the top panel 120 on the thickness of the top panel 120 will be described with reference to FIGS. 15 to 17. The length of the top panel 120 is the length in the Y-axis direction (see FIGS. 2 and 3), and the thickness of the top panel 120 is the thickness in the Z-axis direction (see FIGS. 2 and 3). Additionally, the frequency is the frequency of the drive signal for driving the vibrating element 140, and is equivalent to varying the frequency of the second drive signal.

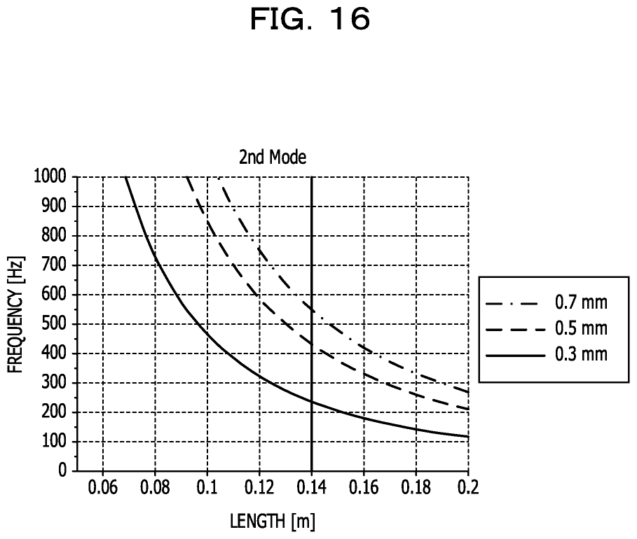

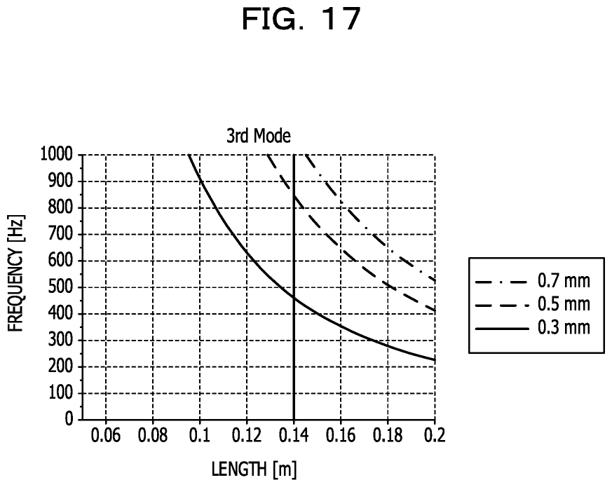

FIGS. 15 to 17 are diagrams illustrating the dependence of the characteristic of the natural frequency (resonance frequency) regarding the length of the top panel 120 on the thickness of the top panel 120. FIG. 15 illustrates the characteristic in a case where a first natural vibration is generated in the top panel 120. FIGS. 16 and 17 illustrate the characteristic in cases where second and third natural vibrations are generated in the top panel 120, respectively.

Additionally, the description herein is given of a case where the glass used for the top panel 120 has a physical property of a Young's modulus of 73 GPa and a density of 2.5×10³ kg/m³. Additionally, top panels 120 having three types of thicknesses: 0.3 mm, 0.55 mm, and 0.7 mm are used.

Additionally, as for the length of the top panel 120, 0.14 m was used as an index as a standard length of a smartphone terminal.

As illustrated in FIGS. 15 to 17, in all cases, the resonance frequency tends to decrease as the length of the top panel 120 increases. This is because the wavelength of the natural vibration becomes longer.

As illustrated in FIG. 15, in the case of the first natural vibration, it has been found that when the length of the top panel 120 is around 0.14 m and the thickness of the top panel 120 is 0.55 mm and 0.7 mm, the frequency falls within the frequency band of 150 Hz to 400 Hz, and when the thickness of the top panel 120 is 0.3 mm, the frequency is 100 Hz or lower when the length of the top panel 120 is around 0.14 m.

Incidentally, in order to generate a first natural vibration, it is necessary to place a vibrating element 140 having a length equal to the length of the top panel 120 in the Y-axis direction, or place the vibrating element 140 at the center of one antinode formed on the top panel 120 (center of length of top panel 120 in Y-axis direction). In these cases, since the display panel 160 and the vibrating element 140 overlap, it is not realistic to cause the first natural vibration in the top panel 120 to provide a tactile sensation.

As illustrated in FIG. 16, in the case of the second natural vibration, it has been found that when the length of the top panel 120 is around 0.14 m and the thickness of the top panel 120 is 0.3 mm, the frequency falls within the frequency band of 150 Hz to 400 Hz, and when the thickness of the top panel 120 is 0.55 mm and 0.7 mm, the frequency is 400 Hz or higher when the length of the top panel 120 is around 0.14 m.

Additionally, as illustrated in FIG. 17, in the case of the third natural vibration, it has been found that when the thickness of the top panel 120 is 0.3 mm, the frequency falls within the frequency band of 400 Hz or lower when the length of the top panel 120 is about 0.15 mm or more, and when the thickness of the top panel 120 is 0.55 mm and 0.7 mm, the frequency does not fall within the frequency band of 400 Hz or lower even if the length of the top panel 120 is increased to 0.2 m.

As described above, it has been found that in the electronic device 100, in order to generate vibration in a frequency band perceivable by the human sensory organ on the surface 120A of the top panel 120, the optimal thickness of the top panel 120 is 0.3 mm among the three types of thicknesses 0.3 mm, 0.55 mm, and 0.7 mm.

Note that in a case of generating a natural vibration in the ultrasonic band on the surface 120A of the top panel 120 to provide a tactile sensation, a sine wave signal in the ultrasonic band output from the sine wave generator 310 is modulated to 350 Hz by the amplitude modulator 320.

In this case, as illustrated in FIGS. 4A and 4B, it has been confirmed that a tactile sensation perceivable by the user with his/her fingertip can be provided when the thickness of the top panel 120 is 0.7 mm. Additionally, it has been confirmed that even when the thickness of the top panel 120 is 0.3 mm and 0.55 mm, a tactile sensation perceivable by the user with his/her fingertip can be provided as in the case of the thickness of 0.7 mm. That is, setting the thickness of the top panel 120 to an appropriate thickness is important when generating vibration in a frequency band perceivable by the human sensory organ on the surface 120A of the top panel 120, for example.

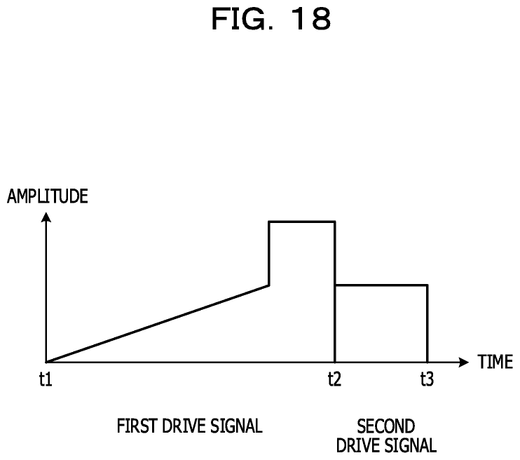

Next, waveforms of the first drive signal and the second drive signal for realizing a vibration pattern for providing a click feeling will be described with reference to FIGS. 18 to 22.

FIGS. 18 to 22 are diagrams illustrating waveforms of the first drive signal and the second drive signal for providing a click feeling. In FIGS. 18 to 22, the horizontal axis represents time, and the vertical axis represents the absolute value of the amplitude.

While the waveforms of the first drive signal and the second drive signal technically have waveforms as illustrated in FIG. 9, here, the variation in amplitude will be described with an envelope of the first drive signal and the second drive signal.

Additionally, the time at which the pressing operation is performed and the driving of the vibrating element 140 by the first drive signal starts is defined as t1, the time at which the driving of the vibrating element 140 by the first drive signal ends and the driving is switched to driving by the second drive signal is defined as t2, and the time at which the driving of the vibrating element 140 by the second drive signal ends is defined as t3. Times t1, t2, and t3 are similar to those illustrated in FIG. 9.

The waveform illustrated in FIG. 18 is a waveform close to the envelope of the waveform illustrated in FIG. 9. The waveform illustrated in FIG. 18 varies linearly, which is different from the nonlinear envelope of the waveform of the first drive signal illustrated in FIG. 9. Note that the waveform of the second drive signal illustrated in FIG. 18 is similar to the waveform of the second drive signal illustrated in FIG. 9.

As described above, when the vibrating element 140 is driven by the pressing operation, the amplitude of the first drive signal may be linearly increased according to change in time. This is to gradually reduce the frictional force applied to the fingertip by the squeeze effect, and provide a tactile sensation that the fingertip gradually moves more smoothly. Additionally, since the time for driving the vibrating element 140 with the second drive signal is shorter than the time for driving the vibrating element 140 with the first drive signal, the amplitude may be constant.

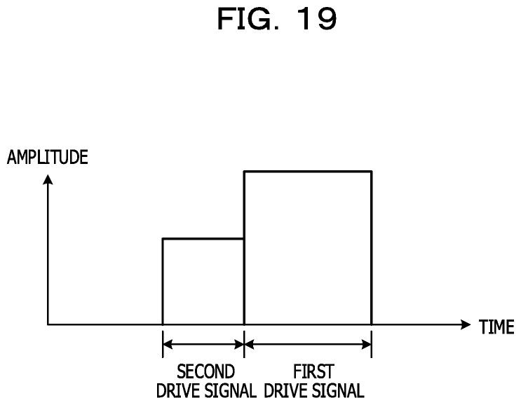

In the waveform illustrated in FIG. 19, the order of driving by the first drive signal and the second drive signal is reversed from the waveform illustrated in FIG. 18. Additionally, the amplitudes of the first drive signal and the second drive signal are both constant.

This is a vibration pattern in which the vibrating element 140 is first driven by the second drive signal to provide a clicking tactile sensation to the user's fingertip, and then the vibrating element 140 is driven by the first drive signal to provide a smoothly movable tactile sensation to the fingertip.

Although the tactile sensation thus provided to the user's fingertip by driving the vibrating element 140 with the second drive signal and then driving the vibrating element 140 with the first drive signal may provide a smaller click feeling than the vibration pattern illustrated in FIG. 18, the vibrating element 140 may be driven in such an order.

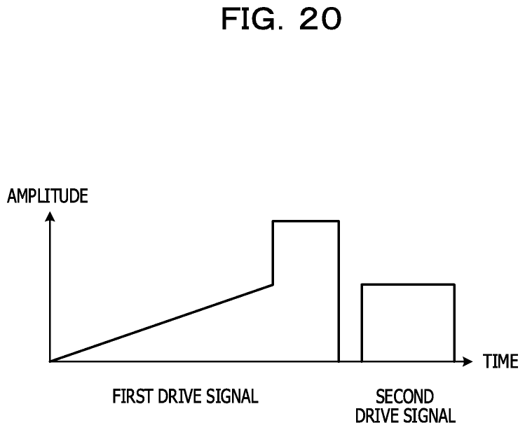

The waveform illustrated in FIG. 20 is obtained by providing an interval where the vibrating element 140 is not driven between the first drive signal and the second drive signal illustrated in FIG. 18. As described above, after the vibrating element 140 is driven by the first drive signal, a section in which the vibrating element 140 is not driven may be provided, and then the vibrating element 140 may be driven by the second drive signal.

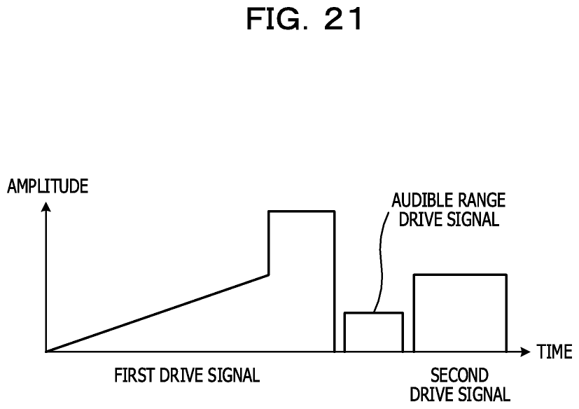

The waveform illustrated in FIG. 21 is obtained by increasing the interval between the first drive signal and the second drive signal illustrated in FIG. 20, and providing a section in which the vibrating element 140 is driven by a drive signal having a frequency in an audible range (audible range drive signal). As described above, the audible range drive signal is a drive signal for driving the vibrating element 140 at an audible frequency of 20 Hz to 20 kHz, for example, and is a drive signal for causing the top panel 120 to generate an audible sound.

It is sufficient if the frequency is determined by selecting a frequency at which the top panel 120 generates sound in the audible range. After the vibrating element 140 is driven by the first drive signal, an audible sound is generated from the top panel 120, and then the vibrating element 140 is driven by the second drive signal. For example, if the frequency and amplitude of the audible range drive signal are set so as to give an instantaneous clicking sound, a sound is generated when providing the tactile sensation of clicking, thereby making it easier for the user to feel the click feeling.

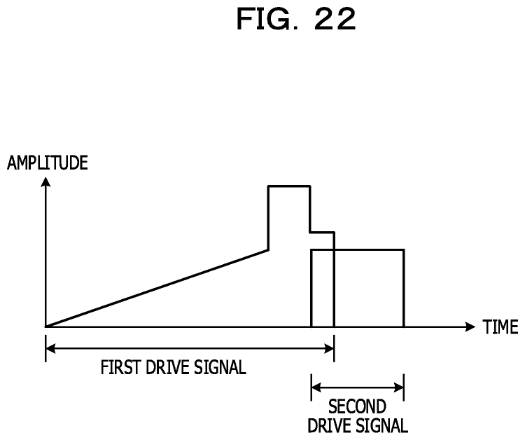

The waveform illustrated in FIG. 22 is obtained by providing an overlap between the first drive signal and the second drive signal illustrated in FIG. 18. As described above, when the vibrating element 140 has been driven by the first drive signal and then the driving is to be switched to the second drive signal, the vibrating element 140 may be driven by providing an overlapping section.

As described above, according to the embodiment, when a pressing operation is performed from a state in which the user's fingertip touches the top panel 120 and is stationary, the vibrating element 140 is driven by the first drive signal that generates the natural vibration in the ultrasonic band, and is then driven by the second drive signal in a frequency band perceivable by the human sensory organ.

Hence, after reducing the dynamic friction force applied to the user's fingertip by the first drive signal, a click impact can be generated by the second drive signal.

With this configuration, it is possible to provide a tactile sensation simulating a tactile sensation received when a mechanical button such as a metal dome button is pressed.

Accordingly, the drive control device 300, the electronic device 100, and a drive control method capable of providing a favorable tactile sensation can be provided.

Note that the above description has been given of a mode in which the vibration pattern P11 (see FIGS. 8 and 9) used to provide the click feeling is a vibration pattern in which the amplitude increases with the passage of time. However, the vibration pattern P11 may be a vibration pattern in which the amplitude does not change with the passage of time and is kept at a constant amplitude.

Additionally, the above description has been given of a mode in which the pressing operation determination unit 250 outputs a pressing event in response to an operation of pressing a GUI operation unit that receives a pressing operation, such as a GUI operation unit representing a button image. However, the pressing operation determination unit 250 may be configured to output a pressing event when an operational input of pressing the top panel 120 is performed in a state where the GUI operation unit is not displayed. Additionally, in this case, the electronic device 100 does not necessarily have to include display panel 160. That is, in a configuration such as a touch pad, a tactile sensation indicating a click feeling may be provided, for example.

Additionally, while the above description has been given of a mode in which the pressing operation determination unit 250 detects the pressing operation, to detect the pressing operation, a load applied to the top panel 120 may be measured using a load meter or the like, and the pressing operation may be detected when the measured value is equal to or larger than a threshold value. Additionally, a transparent electrode may be provided on the back surface of the top panel 120 and a conductive plate having a ground potential may be provided on the back surface side of the display panel 160, so that a change in capacitance between the transparent electrode and the conductive plate may be detected to detect presence or absence of a pressing operation.

Additionally, while the above description has been given of a mode in which the user performs an operational input on the top panel 120 with his/her fingertip, the user may hold a tool such as a stylus pen or a touch pen in his/her hand, and perform an operational input on the top panel 120 with the stylus pen or the touch pen. Even in such a case, a tactile sensation indicating a click feeling can be provided to the user's hand through the stylus pen or the touch pen.

Additionally, while the above description has been given of a mode in which both the first drive signal and the second drive signal generate natural vibrations having different modes on the surface 120A of the top panel 120 to provide a tactile sensation indicating a click feeling, the vibration in the frequency band perceivable by the human sensory organ generated by the second drive signal does not need to be a natural vibration. This is because, compared to the vibration in the ultrasonic band generated by the first drive signal, the vibration in the frequency band perceivable by the human sensory organ can be detected even with a small amplitude.

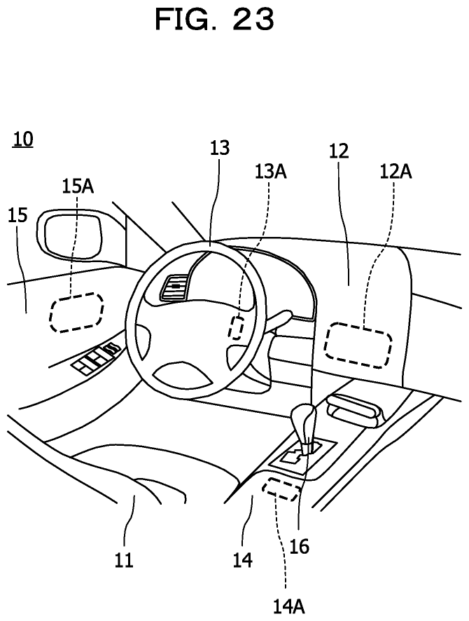

Additionally, the electronic device 100 may be mounted on a vehicle as illustrated in FIG. 23. FIG. 23 is a diagram illustrating the periphery of a driver's seat 11 in the interior of a vehicle 10. Inside the vehicle 10, a driver's seat 11, a dashboard 12, a steering wheel 13, a center console 14, a door lining 15 and the like are disposed. Note that it is sufficient if the vehicle 10 is a hybrid vehicle (HV), an electric vehicle (EV), a gasoline engine vehicle, a diesel engine vehicle, a fuel cell vehicle (FCV), a hydrogen vehicle, or the like, for example.

The electronic device 100 according to the embodiment may be disposed, for example, in a central portion 12A of the dashboard 12, a spoke portion 13A of the steering wheel 13, the periphery 14A of a shift lever 16 of the center console 14, a recess 15A in the door lining 15, or the like.

The electronic device 100 may be provided in the central portion 12A of the dashboard 12, and an electronic device without the display panel 160 may be provided in the periphery 14A of the shift lever 16 of the center console 14 as an input device. In this case, the electronic device 100 provided in the central portion 12A may be operated through the electronic device (input device) without the display panel 160 provided in the periphery 14A. The electronic device 100 provided in the central portion 12A need not include the touch panel 150 and the drive control device 300.

Additionally, an electronic device (input device) without the display panel 160 may be provided as a power window switch in the recess 15A in the door lining 15, or may be provided outside the vehicle 10. For example, the electronic device may be provided around a door handle to be used as an operation portion of an electronic lock.

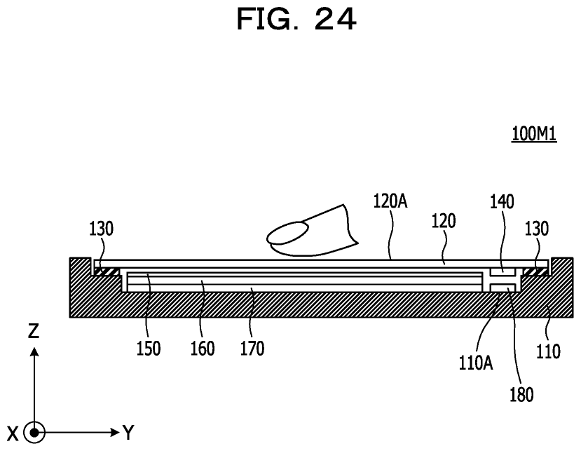

FIG. 24 is a diagram illustrating a cross section with arrows taken along line A-A of an electronic device 100M1 according to a modification of the embodiment. The cross section illustrated in FIG. 24 corresponds to the cross section illustrated in FIG. 3.

The electronic device 100M1 includes a housing 110, a top panel 120, a double-sided tape 130, a vibrating element 140, a touch panel 150, a display panel 160, a substrate 170, and a linear resonant actuator (LRA) 180.

The LRA 180 is disposed in the recess 110A of the housing 110, for example. The position of the LRA 180 in a plan view is substantially equal to the position of the vibrating element 140, for example. The LRA 180 generates vibration in a frequency band perceivable by the human sensory organ. The LRA 180 is an example of a second vibrating element.

In the electronic device 100M1, when providing a tactile sensation indicating a click feeling, a drive control unit 240 drives the vibrating element 140 with a first drive signal, and then drives the LRA 180 with a second drive signal. The amplitude (intensity) and frequency of the vibration generated by the LRA 180 are set by a drive signal (second drive signal). Additionally, on/off of the LRA 180 is controlled by a drive signal (second drive signal). Note that when driving the LRA 180, the vibration generated in the top panel 120 need not be a natural vibration.

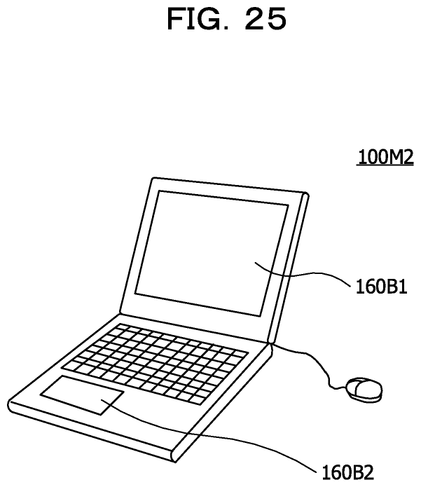

FIG. 25 is a diagram illustrating an electronic device 100M2 according to a second modification of the embodiment. The electronic device 100M2 is a laptop personal computer (PC).

The electronic device 100M2 includes a display panel 160B1, and a touch pad 160B2.

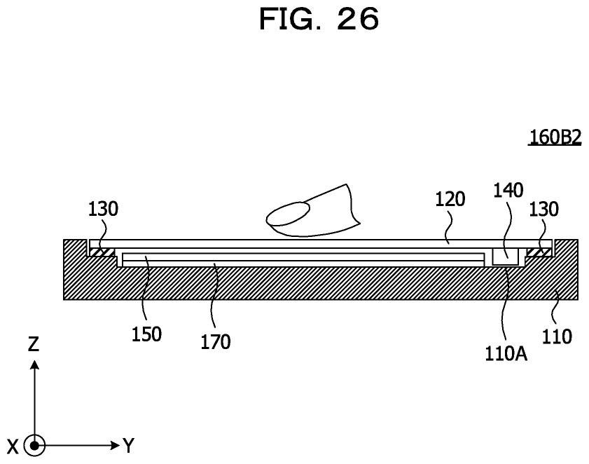

FIG. 26 is a diagram illustrating a cross section of the touch pad 160B2 of the electronic device 100M2 according to a third modification of the embodiment. The cross section illustrated in FIG. 26 is a cross section corresponding to the cross section with arrows taken along line A-A illustrated in FIG. 3. In FIG. 26, the XYZ coordinate system, which is an orthogonal coordinate system, is defined in a similar manner to FIG. 3.

The touch pad 160B2 has a configuration in which the display panel 160 is removed from the electronic device 100 illustrated in FIG. 3.

In the electronic device 100M2 as a PC illustrated in FIG. 25, if on/off of the vibrating element 140 is switched according to operational input to the touch pad 160B2 to generate a natural vibration in the ultrasonic band in the top panel 120, it is possible to provide a feel of operation to the user's fingertip through a tactile sensation according to the amount of movement of the operational input to the touch pad 160B2, in a manner similar to the electronic device 100 illustrated in FIG. 3.

Additionally, if the vibrating element 140 is provided on the back surface of the display panel 160B1, it is possible to provide a feel of operation to the user's fingertip through a tactile sensation according to the amount of movement of the operational input to the display panel 160B1, in a manner similar to the electronic device 100 illustrated in FIG. 3. In this case, it is sufficient if the electronic device 100 illustrated in FIG. 3 is provided instead of the display panel 160B1.

Additionally, by driving the vibrating element 140 with the first drive signal and the second drive signal so as to provide a tactile sensation indicating a click feeling, it is possible to provide a tactile sensation simulating a tactile sensation received when a mechanical button such as a metal dome button is pressed.

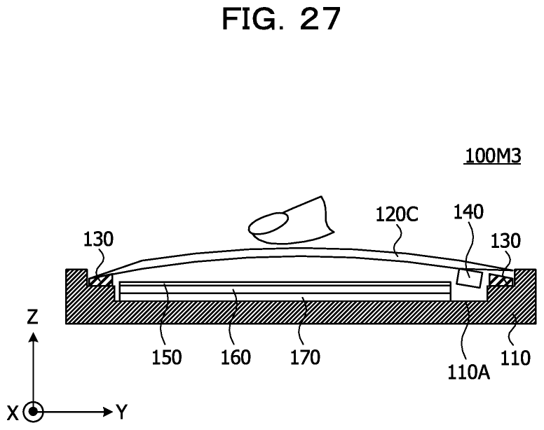

FIG. 27 is a plan view illustrating an operating state of an electronic device 100M3 according to a modification of the embodiment.

The electronic device 100M3 includes a housing 110, a top panel 120C, double-sided tape 130, a vibrating element 140, a touch panel 150, a display panel 160, and a substrate 170.

The electronic device 100M3 illustrated in FIG. 27 has a configuration similar to that of the electronic device 100 according to the embodiment illustrated in FIG. 3 except that the top panel 120C is curved glass.

The top panel 120C is curved such that the center portion in a plan view protrudes to the positive Z-axis direction side. While FIG. 27 illustrates a cross-sectional shape of the top panel 120C in a YZ plane, a cross-sectional shape of the top panel 120C in an XZ plane is formed in a similar manner.

By using the top panel 120C made of curved glass in this manner, it is possible to provide a favorable tactile sensation. This is particularly effective in the case where the actual shape of an object displayed as an image is curved, for example.

Although a drive control device, an electronic device, and a drive control method according to exemplary embodiments have been described above, the embodiment is not limited to those disclosed in detail, and the various changes and alterations could be made hereto without departing from the scope of claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory; and
a processor coupled to the memory and configured to:
drive a vibrating element of an electronic device, which includes a top panel that has an operation surface, a position detection circuit that detects a position of an operational input performed on the operation surface, and the vibrating element that generates vibration on the operation surface, with a first drive signal that generates a first natural vibration in an ultrasonic band on the operation surface when the operational input is performed on the operation surface; and
drive the vibrating element with a second drive signal that generates vibration in a frequency band perceivable by a human sensory organ on the operation surface when the vibrating element is driven for a predetermined time.

2. The information processing device according to claim 1, wherein the processor is configured to:
determine whether an operational input of pressing the operation surface has been performed; and
drive the vibrating element with the first drive signal when determining that an operational input of pressing the operation surface has been performed.

3. An information processing device comprising:
a memory;
a processor coupled to the memory and configured to:
drive a first vibrating element of a vibrating element of an electronic device, which includes a top panel that has an operation surface, a position detection circuit that detects a position of an operational input performed on the operation surface, the first vibrating element that generates vibration on the operation surface, and a second vibrating element that generates vibration on the operation surface, with a first drive signal that generates a first natural vibration in an ultrasonic band on the operation surface when the operational input is performed on the operation surface; and
drive the second vibrating element with a second drive signal that generates vibration in a frequency band perceivable by a human sensory organ on the operation surface when the first vibrating element is driven for a predetermined time.

4. The information processing device according to claim 3, wherein the processor is configured to:
determine whether an operational input of pressing the operation surface has been performed; and
drive the first vibrating element with the first drive signal when determining that an operational input of pressing the operation surface has been performed.

5. The information processing device according to claim 2, wherein a display that is provided on the opposite side of the operation surface of the top panel, and
the processor is configured to:
determine whether an operational input to a graphic user interface (GUI) operation circuit displayed on the display has been performed on the basis of the detected position of the operational input;
perform driving by the first drive signal when determining that an operational input to the GUI operation circuit has been performed; and determine that an operational input of pressing the operation surface has been performed.

6. The information processing device according to claim 1, wherein
the predetermined time is a time corresponding to a time necessary for a user to press a mechanical button.

7. The information processing device according to claim 1, wherein
the second drive signal is a drive signal that generates a second natural vibration in an audible frequency band on the operation surface.

8. The information processing device according to claim 1, wherein
the first drive signal is a drive signal that increases an intensity of the first natural vibration over time.

9. An electronic device comprising:
a top panel including an operation surface;
a position detection circuit configured to detect a position of an operational input performed on the operation surface;
a vibrating element configured to generate vibration on the operation surface; and
a processor configured to:
drive the vibrating element with a first drive signal that generates a first natural vibration in an ultrasonic band on the operation surface when the operational input is performed on the operation surface; and
drive the vibrating element with a second drive signal that generates vibration in a frequency band perceivable by a human sensory organ on the operation surface when the vibrating element is driven for a predetermined time.
